(19) United States
(12) Patent Application Publication
(10) Pub. No.: US 2015/0316740 A1
(43) Pub. Date: Nov. 5, 2015

(54) ATTACHABLE AND DETACHABLE FIBER OPTIC CABLE RADIUS CONTROLLER

(71) Applicant: CORNING OPTICAL COMMUNICATIONS LLC, HICKORY, NC (US)

(72) Inventors: William Julius McPhil Giraud, Azle, TX (US); Diana Rodriguez, Fort Worth, TX (US)

(21) Appl. No.: 14/704,344

(22) Filed: May 5, 2015

Related U.S. Application Data
(60) Provisional application No. 61/988,604, filed on May 5, 2014.

(51) Int. Cl. G02B 6/44

(52) U.S. Cl. CPC G02B 6/4478; G02B 6/4454

(57) ABSTRACT

A radius controller for maintaining and routing fiber optic cables is disclosed. The radius controller has a base with first and second walls extending from the base and defining a space adapted to receive, maintain and route fiber optic cables. The first wall has a first attachment feature and the second wall has a second attachment feature. The first and second attachment features are configured to attach and detach the radius controller to and from a fiber optic cassette.

### PRIORITY APPLICATION

This application claims the benefit of priority under 35 U.S.C. §119 of U.S. Provisional Application Serial No. 61/988,604 filed on May 5, 2014, the content of which is relied upon and incorporated herein by reference in its entirety.

### BACKGROUND

1. Field of the Disclosure

The disclosure relates generally to optical cable apparatus and, more particularly, to a radius controller which can be toollessly attached and detached from a fiber optic cassette.

2. Technical Background

In optical cable networking apparatus including convergence points and distribution frames, such as in fiber-optics networking, there is an increasing demand for components that facilitate high-density distribution with very high fiber termination counts in a small, confined volume. The distribution frames may be located in central offices while the convergence points may be outdoor cabinets located throughout the network. Accomplishing the high-density distribution with high fiber termination counts requires efficient utilization of space with due regard to constraints put on optical cables, such as minimum bending radius. As such, an ongoing need exists for optical-cable networking components that can effectively utilize a confined volume when large numbers of optical cables are present, while simultaneously avoiding sharp bends to the optical cables.

### SUMMARY

One embodiment relates to a radius controller for maintaining and routing fiber optic cables. The radius controller has a base with first and second walls extending therefrom and defining a space adapted to receive, maintain, and/or route fiber optic cables. The first wall has a first attachment feature and the second wall has a second attachment feature. The first and second attachment features are configured to attach and detach the radius controller to and from a fiber optic cassette.

Additional features and advantages will be set forth in the detailed description which follows, and in part should be readily apparent to those skilled in the art from the description or recognized by practicing the embodiments as described in the written description and claims hereof, as well as the appended drawings. It is to be understood that both the foregoing general description and the following detailed description describe various embodiments and are intended to provide an overview or framework for understanding the nature and character of the claimed subject matter.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective top view of an attachable and detachable radius controller according to one or more embodiments described herein, shown detached;

FIG. 2 is a partial, perspective top view of the radius controller of FIG. 1 shown attached to a cable routing tray of a cassette;

FIG. 3A is a perspective top view of a cassette without the radius controller of FIG. 1; and

FIG. 3B is a perspective top view of a cassette with the radius controller of FIG. 1 attached to the cable routing tray.

### DETAILED DESCRIPTION

Embodiments of radius controllers for optical cables are described with reference to the figures. Embodiments include a radius controller for maintaining and routing fiber optic cables. The radius controller has a base with first and second walls extending therefrom and defining a space adapted to receive, maintain, and route fiber optic cables. The first wall has a first attachment feature and the second wall has a second attachment feature. The first and second attachment features are configured to attach and detach the radius controller to and from a fiber optic cassette. In this way, the radius controller may be snapped in an existing cassette cable routing tray including a cable routing try which may include a drop handle or provide a drop handle function.

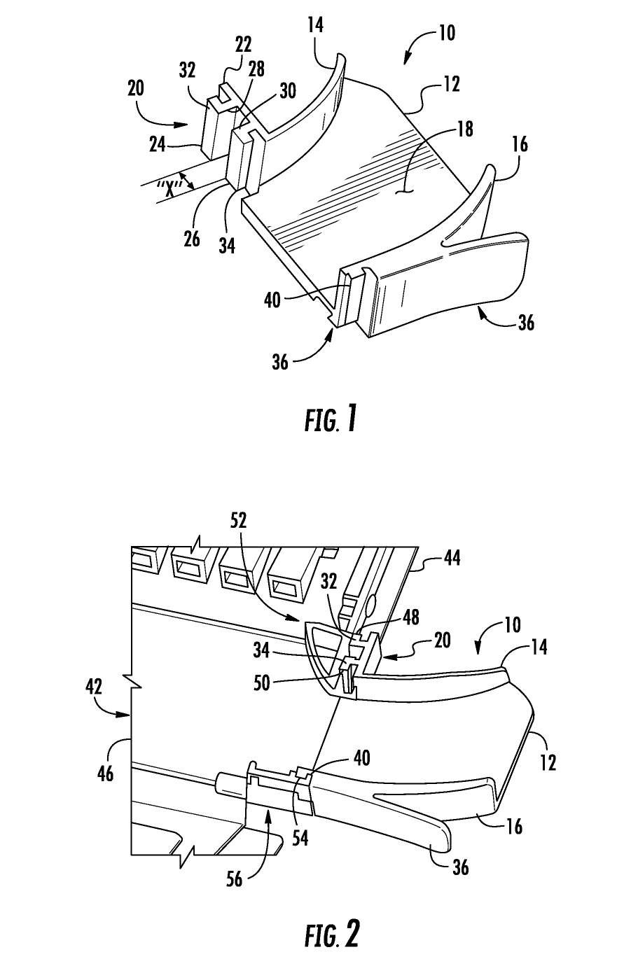

Referring to FIG. 1 there is show a radius controller 10. The radius controller 10 includes a base 12. First wall 14 and second wall 16 extend from the base 12. The base 12, first wall 14, and second wall 16 define a space 18 adapted to receive fiber optic cables (not shown in FIG. 1). The first wall 14 and second wall 16 may be curvilinear, making the space 18 similarly curvilinear. In this way, base 12, first wall 14 and second wall 16 retain, manage and direct the fiber optic cables as they position in and pass through the radius controller 10.

First wall 14 has a first attachment feature 20 located at one end. The first attachment feature 20 may include support 22, first bracket 24 and second bracket 26. First bracket 24 and second bracket 26 may be “L” shaped and extend from support 22 via segments 28, 30, respectively. Segments 28, 30 may be separated by a distance “X” and tabs 32, 34 may extend from segments 28, 30, respectively, in opposite directions. Second wall 16 may have a pull 36 and a second attachment feature 38. The second attachment feature 38 may include a protrusion 40 extending from and located at one end of second wall 16 first attachment feature 20 and second attachment feature 38 may be configured to toollessly attach and detach radius controller 10 to and from a cable routing tray of cassette (not shown in FIG. 1), which will be discussed in more detail below. Radius controller 10 may be formed or molded as one piece, in other words monolithically, from any suitable material including, as non-limiting examples, plastic or metal. Alternatively, radius controller 10 may be constructed of multiple pieces from any suitable material or combination of materials.

Referring now to FIG. 2, there is shown radius controller 10 toollessly attached to cable routing tray 42 of cassette 44. Base 12 of radius controller 10 may interface with base 46 of cable routing tray 42 in a manner such that they form a flush surface at the transition from base 46 to base 12. First wall 14 of radius controller 10 interfaces with cable routing tray 42 such that tabs 32, 34 of first attachment feature 20 may insert into channels 48, 50, respectively, of first receiver 52 formed in cable routing tray 42 as is shown in FIG. 2. Second wall 16 of radius controller 10 interfaces with cable routing tray 42 such that protrusion 40 of second attachment feature 38 may insert into groove 54 of second receiver 56, as is shown in FIG. 2. In this manner, first attachment feature 20 may be inserted into first receiver 52 and second attachment feature 38 may be inserted into second receiver 56 from above the cable routing tray 42. Radius controller 10 may then be vertically lowered by sliding first attachment feature 20 into first receiver 52 and second attachment feature 38 into second receiver 56 to attach radius controller 10 to cable routing tray 42. Detaching radius controller 10 from cable routing tray 42 may be accomplished by lifting the radius controller 10 from the cable routing tray 42 thereby removing first attachment feature 20 from first receiver 52 and second attachment feature 38 from second receiver 56.

In certain embodiments, groove 54 and protrusion 40 may be configured to form an interference fit to hold radius controller 10 to cassette 44 without requiring additional tools or fasteners. Alternatively or additionally, groove 54 and protrusion 40 may be configured with complementary tabs/detents to form a “snap-fit” or “press-fit” interface to toollessly secure radius controller 10 to cassette 44.

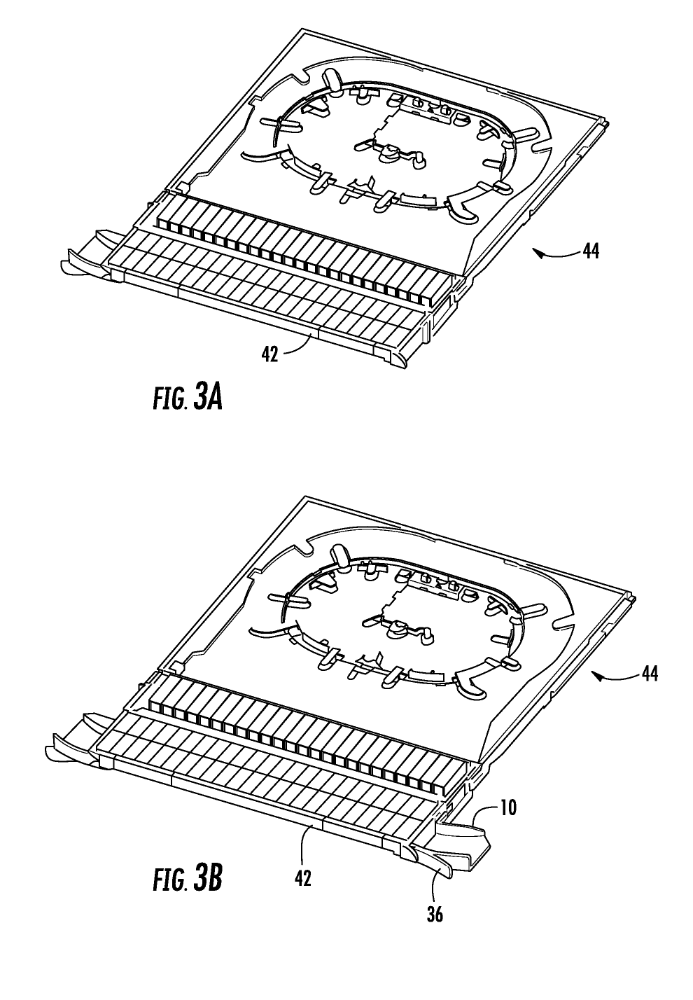

Turning now to FIGS. 3A and 3B, there are shown cassette 44 without the radius controller 10 attached to cable routing tray 42 and with controller 10 attached to cable routing tray 42, respectively. As can be seen from FIG. 3A, without radius controller 10, fiber optic cables (not shown in FIGS. 3A or 3B) may only be directed out of cable routing tray 42 and away from cassette 44 to the left as viewed in FIG. 3A. With radius controller 10 attached to cable routing tray 42 fiber optic cables may be directed out of cable routing tray 42 and away from cassette 44 to both the left and the right as viewed in FIG. 3B. Additionally, the curvilinear shape of space 18 may direct fiber optic cable toward the rear or backend of as well as away from cassette 44. Further, pull 36 may be used to remove cassette 44 from a housing or chassis (not shown in FIGS. 3A and 3B).

Cassette 40 may include a tray base having a tray top surface. A tray center portion may be defined on the tray top surface inside a plurality of tray cable securing members arranged around a center-portion periphery of the tray center portion. The tray center portion may have a tray proximal zone and a tray distal zone defined thereon. The cassette 40 may further include a device holder removably and hingedly attached to the tray base and having a holder-closed position and a holder-open position. The device holder may include a holder inner surface and a holder outer surface opposite the holder inner surface. The holder inner surface may have a holder proximal zone and a holder distal zone defined thereon. The device holder may include a plurality of holder cable securing members arranged around a holder periphery of the device holder. At least one device securing member may be disposed in the holder proximal zone and configured to secure an optical device to the holder inner surface. When the device holder is in the holder-closed position and an optical device is secured in the at least one device securing member of the device holder, the holder distal zone overlies the tray distal zone and the optical device overlies the tray proximal zone.

In some embodiments the cassette 40 may contain one or more additional features shown in the figures. For example, the cassette 40 may include an adapter bank that includes a plurality of adapters for connecting external devices (not shown) to optical cables within the cassette 40. As another example of an additional feature, the cassette 40 may include a drop handle having a cable guidance end. The drop handle may cover the adapter panel when the adapter panel is not in use or may protect connectors that are plugged into the adapter panel when the adapter panel is in use. The drop handle also may include a pivot or hinge that allows the drop handle to swing up and down to provide access to the adapter panel.

As another example of an additional feature, the cassette 40 may include a tray cover hingedly attached to the tray base on a side of the tray base by a cover hinge, for example. In such embodiments, the tray cover may be made of a transparent or translucent material that enables a technician to view connections and devices on the tray base through the tray cover.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims.

It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A radius controller for optical cables comprising:
a base,
a first wall and a second wall extending from the base to define a space adapted to receive fiber optic cables;
a first attachment feature located at one end of the first wall; and
a second attachment feature located at one end of the second wall,
wherein the first attachment feature and the second attachment feature are configured to toollessly attach and detach the radius controller to and from a fiber optic cassette.

2. The radius controller of claim 1, wherein the first attachment feature and the second attachment feature are configured to slideably connect to the fiber optic cassette.

3. The radius controller of claim 2, wherein the first attachment feature and the second attachment feature are configured to form an interference fit with a first receiver and a second receiver, respectively, of the fiber optic cassette.

4. The radius controller of claim 2, wherein the first attachment feature and the second attachment feature are configured to form a snap-fit with a first receiver and a second receiver, respectively, of the fiber optic cassette.

5. The radius controller of claim 2, further including a pull-tab configured to disengage at least a portion of one of the first attachment feature or the second attachment feature from the respective first receiver or the second receiver, respectively, of the fiber optic cassette.

6. A splice cassette, comprising:
a housing defining a center portion configured to store fiber optic cable;
a cable routing tray positioned toward the front of the housing and configured to support one or more fiber optic cables positioned thereon; and
a radius controller, removably coupled to at least a portion of the splice cassette, the radius controller comprising:
a base,
a first wall and a second wall extending from the base to define a space adapted to receive fiber optic cables;
a first attachment feature located at one end of the first wall; and
a second attachment feature located at one end of the second wall,
wherein the first attachment feature and the second attachment feature are configured to toollessly attach and detach the radius controller to and from the at least a portion of the splice cassette.

7. The splice cassette of claim 6, wherein the first attachment feature and the second attachment feature are configured to slideably connect to the fiber optic cassette.

8. The splice cassette of claim 7, wherein the first attachment feature and the second attachment feature are configured to form an interference fit with a first receiver and a second receiver, respectively, of the fiber optic cassette.

9. The splice cassette of claim 7, wherein the first attachment feature and the second attachment feature are configured to form a snap-fit with a first receiver and a second receiver, respectively, of the fiber optic cassette.

10. The splice cassette of claim 6, wherein the radius controller further includes a pull-tab configured to disengage at least a portion of one of the first attachment feature or the second attachment feature from the respective first receiver or the second receiver, respectively, of the fiber optic cassette.
